(19) United States
(12) Patent Application Publication
(10) Pub. No.: US 2026/0160373 A1
(43) Pub. Date: Jun. 11, 2026

(54) SOUND PRESSURE REDUCING STRUCTURE

(71) Applicant: NISSAN MOTOR CO., LTD., Yokohama-shi, Kanagawa (JP)

(72) Inventors: Kenichi TOYOSHIMA, Kanagawa (JP); Masaki TANAKA, Kanagawa (JP); Kenta MINAMI, Kanagawa (JP)

(73) Assignee: NISSAN MOTOR CO., LTD., Yokohama-shi, Kanagawa (JP)

(21) Appl. No.: 19/150,108

(22) PCT Filed: Jan. 25, 2023
(86) PCT No.: PCT/JP2023/002264

§ 371 Date: Jul. 22, 2025

(51) Int. Cl. F16L 55/033; G10K 11/04; G10K 11/172

(52) U.S. Cl. CPC F16L 55/033; G10K 11/04; G10K 11/172

(57) ABSTRACT

A sound pressure reducing structure includes: a pipeline; a λ/4 resonance tube having a resonance frequency higher than a primary resonance frequency of the pipeline and lower than a secondary resonance frequency of the pipeline; and a connection part provided between the first open end and the second open end of the pipeline, connecting the λ/4 resonance tube to the pipeline.

### TECHNICAL FIELD

The present invention relates to a sound pressure reducing structure.

### BACKGROUND ART

A sound pressure reducing structure is used in various fields to suppress noise. For example, there are many sound sources in an automobile. Since quietness from noise inside and outside a vehicle is required, an effective sound pressure reducing structure is required in an automobile.

A sound pressure reducing structure including a pipeline and a λ/4 resonance tube connected to the pipeline has been proposed (for example, JP 2015-169092 A). The λ/4 resonance tube is connected in a direction intersecting an extending direction of the pipeline, that is, in a branch shape to the side of the pipeline. The λ/4 resonance tube has, for example, the same resonance frequency as a primary resonance frequency of the pipeline.

### SUMMARY OF INVENTION

### Technical Problem

Since the resonance frequency of the λ/4 resonance tube depends on the size of the tube length, it is difficult to change the tube length in the λ/4 resonance tube adjusted to the same resonance frequency as the primary resonance frequency of the pipeline. Due to this, a space for disposing the λ/4 resonance tube is required around the pipeline, and an installation space of the sound pressure reducing structure tends to be large.

Therefore, an object of the present invention is to provide a sound pressure reducing structure capable of reducing a sound pressure near a primary resonance frequency of a pipeline while reducing an installation space.

### Solution to Problem

A sound pressure reducing structure according to an embodiment of the present invention includes: a pipeline having a first open end and a second open end in an extending direction; a λ/4 resonance tube having a resonance frequency higher than a primary resonance frequency of the pipeline and lower than a secondary resonance frequency of the pipeline; and a connection part provided between the first open end and the second open end, connecting the λ/4 resonance tube to the pipeline, and satisfying the following Formula (1), in which the sound pressure reducing structure has a change position b1 at which an acoustic impedance zb at the primary resonance frequency of the pipeline changes discontinuously along the extending direction, and a position a1 closest to the first open end among a plurality of intersections between a derivative za′ of an acoustic impedance za of the pipeline at the resonance frequency of the λ/4 resonance tube and a derivative zb′ of the acoustic impedance zb, and a position of the connection part in the extending direction is between the position a1 and the change position b1.

$$\begin{matrix}[ Mathematical Formula 1 ] & \\ D / 2 < L & ( 1 )\end{matrix}$$

In Formula (1), L represents a size of the connection part in the extending direction, and D represents a size of the pipeline in a radial direction intersecting the extending direction at a position where the connection part is provided.

### BRIEF DESCRIPTION OF DRAWINGS

FIG. 1 is a view illustrating a configuration of a sound pressure reducing structure according to an embodiment of the present invention together with a change in acoustic impedance.

FIG. 2 is a view illustrating a cross-sectional configuration of a connection portion between a pipeline and a λ/4 resonance tube illustrated in FIG. 1.

FIG. 3 is a view illustrating an example of a planar configuration of a connection part illustrated in FIG. 1.

FIG. 4 is a view illustrating a configuration of a sound pressure reducing structure according to a modification.

FIG. 5 is a view illustrating another example of the sound pressure reducing structure illustrated in FIG. 4.

FIG. 6 is a view illustrating an example of a cross-sectional configuration of a λ/4 resonance tube illustrated in FIG. 4 and the like.

FIG. 7 is a view illustrating another example of the sound pressure reducing structure illustrated in FIG. 4.

FIG. 8A is a view illustrating another example of the cross-sectional configuration of the λ/4 resonance tube illustrated in FIG. 4 and the like.

FIG. 8B is a view illustrating another example of the cross-sectional configuration of the λ/4 resonance tube illustrated in FIG. 4 and the like.

FIG. 8C is a view illustrating another example of the cross-sectional configuration of the λ/4 resonance tube illustrated in FIG. 4 and the like.

FIG. 8D is a view illustrating another example of the cross-sectional configuration of the λ/4 resonance tube illustrated in FIG. 4 and the like.

FIG. 8E is a view illustrating another example of the cross-sectional configuration of the λ/4 resonance tube illustrated in FIG. 4 and the like.

FIG. 8F is a view illustrating another example of the cross-sectional configuration of the λ/4 resonance tube illustrated in FIG. 4 and the like.

FIG. 9 is a view for describing a configuration of a sound pressure reducing structure used in Examples.

FIG. 10 is a view showing an evaluation result of a sound pressure reducing effect of Example 1.

FIG. 11 is a view showing an evaluation result of a sound pressure reducing effect of Example 2.

FIG. 12 is a view showing an evaluation result of a sound pressure reducing effect of Example 3.

FIG. 13 is a view showing an evaluation result of a sound pressure reducing effect of Example 4.

FIG. 14 is a view showing an evaluation result of a sound pressure reducing effect of Comparative Example 1.

FIG. 15 is a view showing an evaluation result of a sound pressure reducing effect of Comparative Example 2.

FIG. 16 is a view showing an evaluation result of a sound pressure reducing effect of Comparative Example 3.

### DESCRIPTION OF EMBODIMENTS

A sound pressure reducing structure according to an embodiment of the present invention includes: a pipeline having a first open end and a second open end in an extending direction; a λ/4 resonance tube having a resonance frequency higher than a primary resonance frequency of the pipeline and lower than a secondary resonance frequency of the pipeline; and a connection part provided between the first open end and the second open end, connecting the λ/4 resonance tube to the pipeline, and satisfying the following Formula (1), in which the sound pressure reducing structure has a change position b1 at which an acoustic impedance zb at the primary resonance frequency of the pipeline changes discontinuously along the extending direction, and a position a1 closest to the first open end among a plurality of intersections between a derivative za′ of an acoustic impedance za and a derivative zb′ of the acoustic impedance zb of the pipeline at the resonance frequency of the λ/4 resonance tube, and a position of the connection part in the extending direction is between the position a1 and the change position b1.

$$\begin{matrix}[ Mathematical Formula 2 ] & \\ D / 2 < L & ( 1 )\end{matrix}$$

In Formula (1), L represents a size of the connection part in the extending direction, and D represents a size of the pipeline in a radial direction intersecting the extending direction at a position where the connection part is provided.

With the sound pressure reducing structure according to the present embodiment, since the resonance frequency of the λ/4 resonance tube is higher than the primary resonance frequency of the pipeline, the tube length is shorter than that of a λ/4 resonance tube having the same resonance frequency as the primary resonance frequency of the pipeline. Since the connection part connecting the λ/4 resonance tube and the pipeline satisfies the above Formula (1), and the position of the connection part in the extending direction is between the position a1 closest to the first open end among the plurality of intersections between the derivative za′ of the acoustic impedance za of the pipeline at the resonance frequency of the λ/4 resonance tube and the derivative zb′ of the acoustic impedance zb at the primary resonance frequency of the pipeline, and the change position b1 at which the acoustic impedance zb changes discontinuously along the extending direction, a sound pressure near the primary resonance frequency of the pipeline is reduced. Therefore, it is possible to reduce a sound pressure near the primary resonance frequency of the pipeline while reducing an installation space.

Hereinafter, embodiments of the present invention will be described with reference to the drawings; however, the technical scope of the present invention is not limited only to the following embodiments. Dimensional ratios in the drawings are exaggerated for convenience of description, and may be different from actual ratios. In the present specification, the phrase “M to N” indicating a range means “M or more and N or less”. Unless otherwise specified, operations and measurements of physical properties and the like are performed under the conditions of room temperature (20 to 25° C.)/relative humidity of 40 to 50%.

### EMBODIMENTS

### [Configuration of Sound Pressure Reducing Structure]

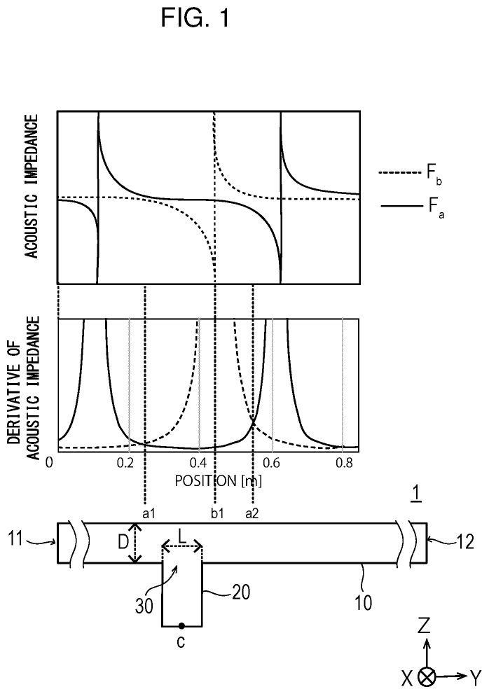

FIG. 1 illustrates a configuration of a sound pressure reducing structure 1 according to an embodiment of the present invention together with a change in acoustic impedance. The sound pressure reducing structure 1 includes a pipeline 10, a λ/4 resonance tube 20 connected to the pipeline 10, and a connection part 30 connecting the pipeline 10 and the λ/4 resonance tube 20.

The pipeline 10 is a hollow member extending in a predetermined direction. A first open end 11 is provided at one end of the pipeline 10 in an extending direction, a second open end 12 is provided at the other end, and for example, sound incident on the pipeline 10 from the first open end 11 is propagated along the extending direction of the pipeline 10 and emitted from the second open end 12. The λ/4 resonance tube 20 is connected in a direction intersecting the extending direction of the pipeline 10. That is, in the sound pressure reducing structure 1, a tube length direction of the λ/4 resonance tube 20 is provided in the direction intersecting the extending direction of the pipeline 10. The connection part 30 connecting the pipeline 10 and the λ/4 resonance tube 20 is provided between the first open end 11 and the second open end 12 in the extending direction of the pipeline 10. In the following description, the extending direction of the pipeline 10 may be referred to as a Y direction, the tube length direction of the λ/4 resonance tube 20 may be referred to as a Z direction, and a direction intersecting the Y direction and the Z direction may be referred to as an X direction.

### (Pipeline 10)

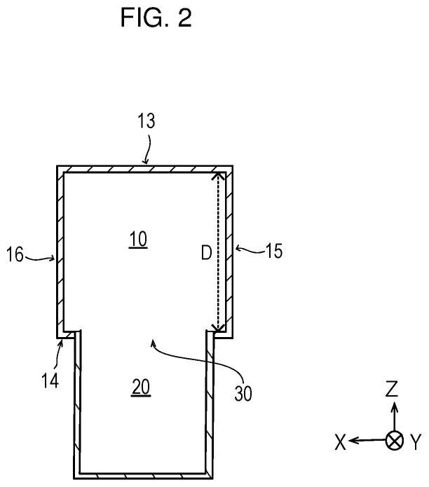

FIG. 2 illustrates an XZ cross section of a connection portion of the pipeline 10 and the λ/4 resonance tube 20. The pipeline 10 has, for example, a quadrangular prism shape having four planes (planes 13, 14, 15, and 16). In the pipeline 10, for example, the plane 13 and the plane 14 are provided to face each other in the Z direction, and the plane 15 and the plane 16 are provided to face each other in the X direction. For example, a slit extending in the Y direction is provided in the plane 14, and an adapter having a through hole is provided in the slit. For example, the λ/4 resonance tube 20 is inserted into the through hole of the adapter. The XZ cross section of the pipeline 10 is, for example, a square.

The pipeline 10 extending in the Y direction has a predetermined size in the radial direction, that is, the Z direction. When the size in the X direction and the size in the Z direction of the pipeline 10 are different, the size of the pipeline 10 in the radial direction is the size of the λ/4 resonance tube 20 in the tube length direction, that is, the size in the Z direction. The size of the pipeline 10 in the radial direction is, for example, a distance between the plane 13 and the plane 14 facing each other in the Z direction. The pipeline 10 has a size D in the radial direction at a position where the connection part 30 is provided, for example. The pipeline 10 has the same size (size D) in the radial direction from the first open end 11 to the second open end 12, for example. The size D of the pipeline 10 in the radial direction may vary between the first open end 11 and the second open end 12. The size D of the pipeline 10 is, for example, about 1 cm to 50 cm. The size of the pipeline 10 in the Y direction is, for example, about 0.1 m to 5 m. The pipeline 10 has a predetermined primary resonance frequency F_{b}. The primary resonance frequency F_{b} of the pipeline 10 is, for example, 50 Hz to 500 Hz.

The acoustic impedance zb at the primary resonance frequency F_{b} of the pipeline 10 changes along the Y direction. The broken line in FIG. 1 represents a change in the acoustic impedance zb in the Y direction at the primary resonance frequency F_{b}. In the pipeline 10, there is a position in the Y direction at which the acoustic impedance zb at the primary resonance frequency F_{b} changes discontinuously (the change position b1 in the Y direction from the first open end 11). The change position b1 is, for example, a center position of the pipeline 10 in the Y direction.

The pipeline 10 is made of, for example, a metal material, a resin material, or the like.

As the metal material, for example, aluminum, titanium, magnesium, tungsten, iron, steel, chromium, chromium molybdenum, nichrome molybdenum, alloys thereof, and the like can be used. As the resin material, for example, polypropylene, polyethylene, an acrylic resin, polymethyl methacrylate, polycarbonate, polyamideimide, polyarylate, polyetherimide, polyacetal, polyether ether ketone, polyphenylene sulfide, polysulfone, polyethylene terephthalate, polybutylene terephthalate, polyimide, triacetyl cellulose, and the like can be used. Other than, materials such as CFRP (Carbon Fiber Reinforced Plastic), carbon fiber, and glass fiber reinforced plastic can also be used.

### (λ/4 Resonance Tube 20)

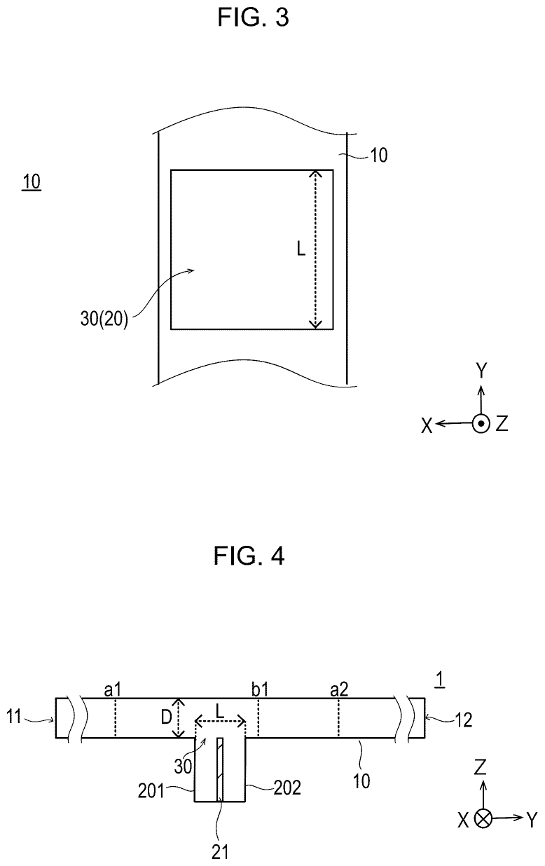

The λ/4 resonance tube 20 connected to the pipeline 10 has a predetermined tube length (size in the Z direction in FIG. 1). The tube length of the λ/4 resonance tube 20 is, for example, 0.05 m to 1 m. The λ/4 resonance tube 20 has an opening at one end in the tube length direction. The opening of the λ/4 resonance tube 20 is connected to the pipeline 10 via the connection part 30. The other end of the λ/4 resonance tube 20 in the tube length direction is closed. Therefore, the sound wave incident on the pipeline 10 from the first open end 11 travels in the Y direction in the pipeline 10 while being affected by the λ/4 resonance tube 20 in the vicinity of the connection part 30. One end and the other end of the λ/4 resonance tube 20 in the tube length direction have, for example, a quadrangular planar shape (see FIG. 3 described later). The λ/4 resonance tube 20 has a center position c in the Y direction.

In the present embodiment, the resonance frequency Fₐ of the λ/4 resonance tube 20 is higher (larger) than the primary resonance frequency F_{b} of the pipeline 10 and lower (smaller) than a secondary resonance frequency F_{c} of the pipeline 10. For example, when the primary resonance frequency F_{b} of the pipeline 10 is about 200 Hz, the secondary resonance frequency F_{c} is about 390 Hz, and the resonance frequency Fₐ of the λ/4 resonance tube 20 is about 330 Hz to 350 Hz. Therefore, as compared with the case of using the λ/4 resonance tube having the same resonance frequency as the primary resonance frequency F_{b} of the pipeline 10, the tube length of the λ/4 resonance tube 20 can be shortened, and the size of the sound pressure reducing structure 1 in the Z direction can be suppressed.

In the sound pressure reducing structure 1 according to the present embodiment, the acoustic impedance za of the pipeline 10 at the frequency Fₐ that is the resonance frequency of the λ/4 resonance tube 20 changes along the Y direction. The solid line in FIG. 1 represents a change in the acoustic impedance za in the Y direction at the resonance frequency Fₐ. In the pipeline 10, generally, there are a plurality of intersections between the derivative za′ of the acoustic impedance za at the resonance frequency Fₐ and the derivative zb′ of the acoustic impedance zb at the primary resonance frequency F_{b} of the pipeline 10, and when a position closest to the first open end 11 among the plurality of intersections is designated as a1, the position of the connection part 30 in the Y direction is closer to the second open end 12 than the position a1.

In the sound pressure reducing structure 1, the connection part 30 of the λ/4 resonance tube 20 to the pipeline 10 is provided between the position a1 and the change position b1 described above (not including the position a1 and the change position b1). As a result, a sound pressure near the primary resonance frequency F_{b} of the pipeline 10 is effectively reduced.

The λ/4 resonance tube 20 is made of, for example, the same material as the material described in the pipeline 10. The constituent material of the λ/4 resonance tube 20 and the constituent material of the pipeline 10 may be the same or different.

### (Connection Part 30)

FIG. 3 illustrates a plane (XY plane) shape of the connection part 30. The connection part 30 is a part that connects the λ/4 resonance tube 20 to the pipeline 10, and the path of the sound wave of the λ/4 resonance tube 20 and the path of the sound wave of the pipeline 10 are connected by the presence of the connection part 30. The size and shape of the connection part 30 are, for example, substantially the same as the size and shape of the opening of the λ/4 resonance tube 20. The size and shape of the connection part 30 may be different from the size and shape of the opening of the λ/4 resonance tube 20. For example, when the size of the opening of the λ/4 resonance tube 20 is different from the size of the opening of the pipeline 10, a portion substantially contributing to the connection between the λ/4 resonance tube 20 and the pipeline 10 is a connection part.

The connection part 30 has, for example, a quadrangular plane (XY plane) shape and has a predetermined size in the X direction and the Y direction. The size of the connection part 30 in the X direction is smaller than the size of the pipeline 10 in the X direction, but is preferably closer to the size of the pipeline 10 in the X direction. The connection part 30 is disposed, for example, substantially at the center of the pipeline 10 in the X direction.

The connection part 30 has a predetermined size L in the Y direction. The size L of the connection part 30 is, for example, substantially the same as the size of the opening in the Y direction of the λ/4 resonance tube 20. In the present embodiment, the size L of the connection part 30 satisfies the following Formula (1). In other words, the size L of the connection part 30 in the Y direction is larger than a half of the size D of the pipeline 10. As a result, a sound pressure near the primary resonance frequency F_{b} of the pipeline 10 is reduced in the sound pressure reducing structure 1, which will be described in detail later.

$$\begin{matrix}[ Mathematical Formula 3 ] & \\ D / 2 < L & ( 1 )\end{matrix}$$

In Formula (1), L represents a size of the connection part 30 in the Y direction, and D represents a size of the pipeline 10 in the Z direction at the position where the connection part 30 is provided.

### [Operation and Effect of Sound Pressure Reducing Structure]

In the sound pressure reducing structure 1, the sound wave incident on the pipeline 10 from the first open end 11 travels along the Y direction and is emitted from the second open end 12. In the present embodiment, the λ/4 resonance tube 20 connected to the pipeline 10 via the connection part 30 has a resonance frequency Fₐ higher than the primary resonance frequency F_{b} of the pipeline 10 and lower than the secondary resonance frequency F_{c} of the pipeline 10. Therefore, as compared with the case of connecting the λ/4 resonance tube having the same resonance frequency as the primary resonance frequency F_{b} of the pipeline 10 to the pipeline 10, the tube length of the λ/4 resonance tube 20 is shortened, so that the size of the sound pressure reducing structure 1 in the Z direction is suppressed. This will be described below.

In the case of reducing a sound pressure near the primary resonance frequency F_{b} of the pipeline 10, it is conceivable to use a λ/4 resonance tube having the same resonance frequency as the primary resonance frequency F_{b}. However, since the resonance frequency of the λ/4 resonance tube depends on its tube length, when the resonance frequency of the λ/4 resonance tube is adjusted to be the same as the primary resonance frequency F_{b} of the pipeline, it is difficult to shorten the tube length. That is, in the sound pressure reducing structure having such a λ/4 resonance tube, the size in a direction (for example, the Z direction) intersecting the extending direction of the pipeline 10 tends to be large.

On the other hand, in the present embodiment, since the λ/4 resonance tube 20 connected to the pipeline 10 has a resonance frequency Fₐ higher than the primary resonance frequency F_{b} of the pipeline 10 and lower than the secondary resonance frequency F_{c} of the pipeline 10, the tube length of the λ/4 resonance tube 20 is shorter than that of the λ/4 resonance tube having the same resonance frequency as the primary resonance frequency F_{b}. As a result, in the sound pressure reducing structure 1, the size in the Z is suppressed.

Since the size L of the connection part 30 in the Y direction satisfies the above Formula (1), the sound pressure near the primary resonance frequency F_{b} of the pipeline 10 is reduced even in the λ/4 resonance tube 20 having a resonance frequency higher than the primary resonance frequency F_{b} and lower than the secondary resonance frequency F_{c}. This is presumed to be because the wavefront of the sound wave traveling in the Y direction through the pipeline 10 is easily disturbed by the connection part 30 satisfying Formula (1), and the mismatch of the acoustic impedance becomes large. Therefore, in the sound pressure reducing structure 1, it is possible to reduce a sound pressure near the primary resonance frequency of the pipeline while reducing an installation space. Note that the mechanism as presumed above does not limit the technical scope of the present invention.

By providing the position in the Y direction of the connection part 30 of the λ/4 resonance tube 20 to the pipeline 10 between the position a1 closest to the first open end 11 among the plurality of intersections between the derivative za′ of the acoustic impedance za and the derivative zb′ of the acoustic impedance zb at the primary resonance frequency F_{b} of the pipeline 10, and the change position b1 at which the acoustic impedance zb discontinuously changes, a sound pressure near the primary resonance frequency F_{b} of the pipeline 10 can be effectively reduced.

Since the pipeline 10 has a pair of planes 13 and 14 facing each other, the connection part 30 can be provided on one of the pair of planes 13 and 14 (the plane 14 in FIG. 2). As a result, the mismatch of the acoustic impedance becomes large, and a sound pressure near the primary resonance frequency F_{b} of the pipeline 10 can be more effectively reduced.

Hereinafter, a modification of the sound pressure reducing structure 1 described in the above embodiment will be described. Note that, in the following description, detailed description of configurations similar to the configurations of the sound pressure reducing structure 1 described in the above embodiment will be omitted in order to avoid duplication of description.

### Modification

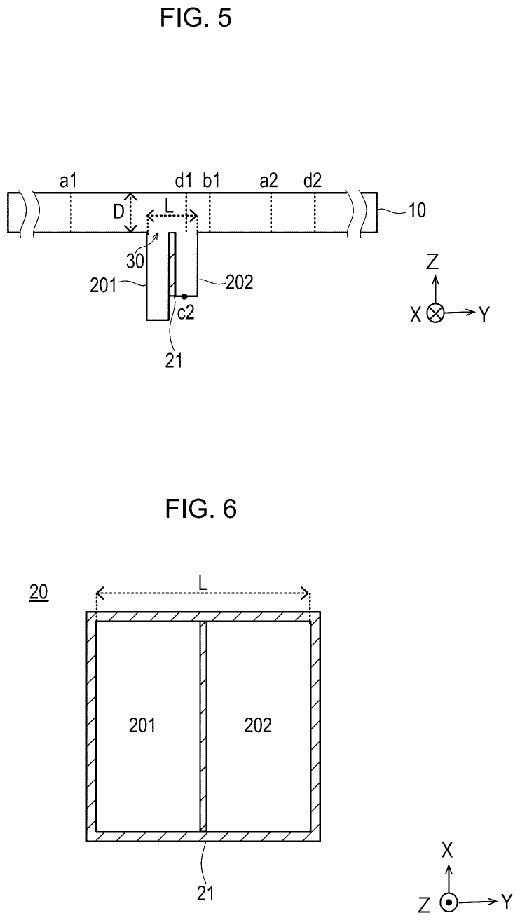

FIGS. 4 and 5 illustrate a configuration of the sound pressure reducing structure 1 according to a modification. In the sound pressure reducing structure 1, a plurality of λ/4 resonance tubes (λ/4 resonance tubes 201 and 202) are connected to the pipeline 10 via the connection part 30. Except for this point, the sound pressure reducing structure 1 according to the modification has the same configuration as the sound pressure reducing structure 1 of the above-described embodiment, and has the same operation and effect.

The λ/4 resonance tubes 201 and 202 connected to the pipeline 10 is provided at a position adjacent in the Y direction via a partition 21. The plurality of λ/4 resonance tubes (λ/4 resonance tubes 201 and 202) are connected to the pipeline 10 via one connection part (connection part 30). The partition 21 is made of, for example, the same material as that of the λ/4 resonance tubes 201 and 202. The thickness (size in the Y direction) of the partition 21 is, for example, about 0.1 mm to 10 mm.

The tube lengths of the λ/4 resonance tubes 201 and 202 may be the same as each other (FIG. 4) or may be different from each other (FIG. 5). The λ/4 resonance tubes 201 and 202 each have a resonance frequency Fₐ higher than the primary resonance frequency F_{b} of the pipeline 10 and lower than the secondary resonance frequency F_{c} of the pipeline 10. The λ/4 resonance tubes 201 and 202 may have the same resonance frequency Fₐ or may have different resonance frequencies Fₐ and F_{d}.

When the tube lengths of the λ/4 resonance tubes 201 and 202 are the same (FIG. 4), the connection part 30 is provided between the position a1 and the change position b1. As a result, a sound pressure near the primary resonance frequency F_{b} of the pipeline 10 is effectively reduced.

When the tube lengths of the λ/4 resonance tubes 201 and 202 are different and the respective resonance frequencies are different from each other (resonance frequencies Fₐ and F_{d}, provided that the resonance frequency Fₐ is smaller than the resonance frequency F_{d}), the position a1 and a position d1 exist in the pipeline 10 (FIG. 5). The position a1 is a position closest to the first open end 11 in the Y direction among the plurality of intersections between the derivative za′ of the acoustic impedance za at a lower resonance frequency Fₐ and the derivative zb′ of the acoustic impedance zb at the primary resonance frequency F_{b} of the pipeline 10. The position d1 is a position closest to the first open end 11 in the Y direction among the plurality of intersections between a derivative zd′ of an acoustic impedance zd at a higher resonance frequency F_{d} and the derivative zb′ of the acoustic impedance zb at the primary resonance frequency F_{b} of the pipeline 10.

At this time, a portion of connection part 30 corresponding to the λ/4 resonance tube 201 having a lower resonance frequency Fₐ is preferably provided between the position a1 and the change position b1. The λ/4 resonance tube 201 having a longer tube length is responsible for reducing a sound pressure near the primary resonance frequency F_{b} of the pipeline 10, and the λ/4 resonance tube 202 has a tube length shorter than that of the λ/4 resonance tube 201, so that the size of the sound pressure reducing structure 1 in the Z direction is suppressed. A center position c2 of the λ/4 resonance tube 202 having a higher resonance frequency F_{d} is preferably disposed at a change position (not illustrated) in the Y direction at which the acoustic impedance at the resonance frequency F_{d} discontinuously changes. As a result, in the sound pressure reducing structure 1, a sound pressure near the resonance frequency F_{d} of the λ/4 resonance tube 202 is also reduced together with a sound pressure near the primary resonance frequency F_{b} of the pipeline 10.

FIG. 6 illustrates a configuration of a cross section (XY cross section) of the λ/4 resonance tubes 201 and 202 and the partition 21. For example, the size L of the connection part 30 is substantially equal to the sum of the size in the Y direction of the opening of the λ/4 resonance tubes 201 and 202 and the thickness of the partition 21. The size L of the connection part 30 satisfies the above Formula (1) in relation with D.

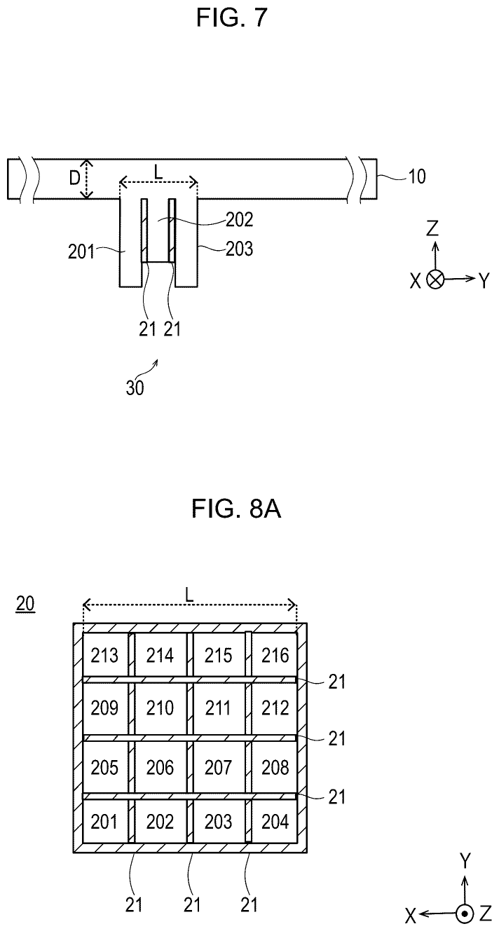

FIG. 7 illustrates another example of the sound pressure reducing structure 1 illustrated in FIGS. 4 and 5. As illustrated in FIG. 7, the sound pressure reducing structure 1 may include three λ/4 resonance tubes (λ/4 resonance tubes 201, 202, and 203) adjacent to each other in the Y direction via the partition 21, or may include four or more λ/4 resonance tubes. The three or more λ/4 resonance tubes may have the same resonance frequency (not illustrated) or some or all of them may have different resonance frequencies.

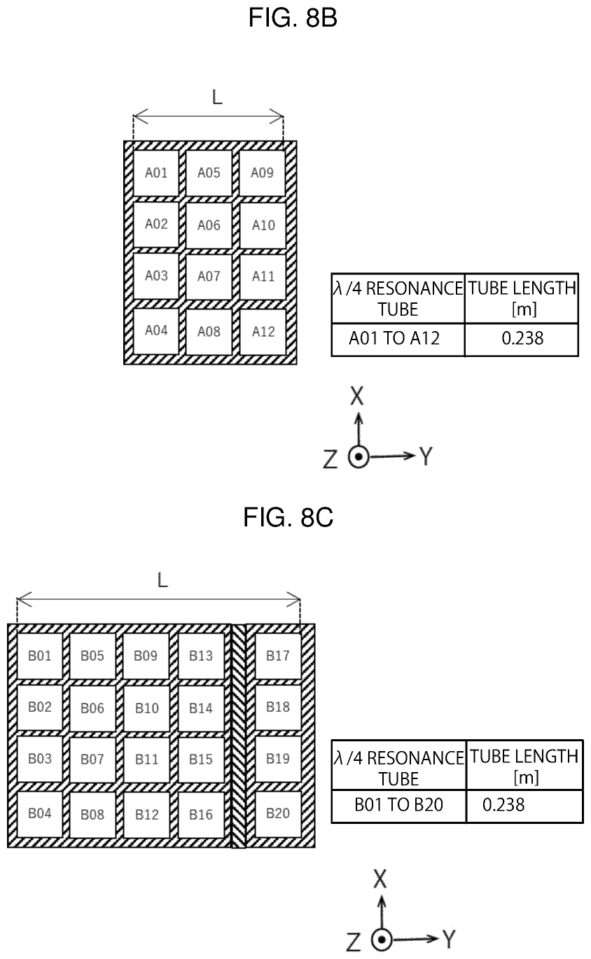

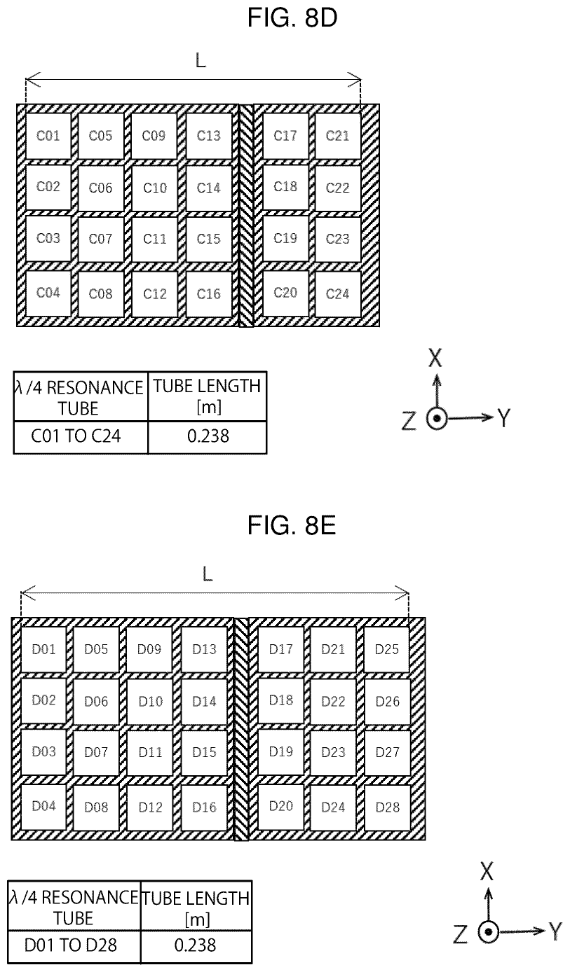

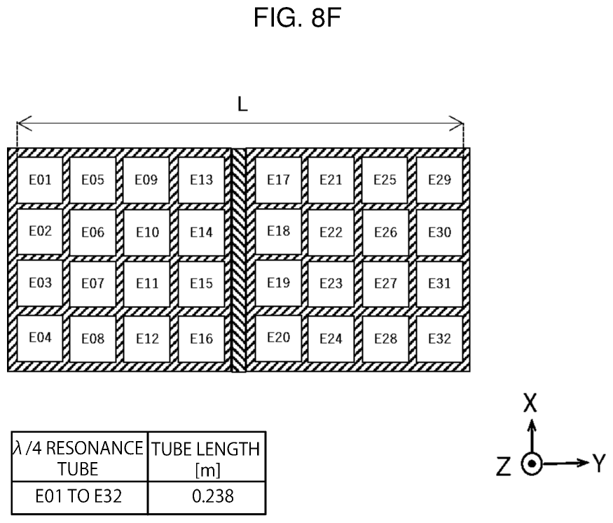

FIG. 8A illustrates another example of the configuration of the cross section (XY cross section) of the λ/4 resonance tubes (λ/4 resonance tubes 201 to 216) and the partition 21. The sound pressure reducing structure 1 may include a plurality of λ/4 resonance tubes (for example, λ/4 resonance tubes 201, 205, 209, and 213) adjacent to each other in the X direction via the partition 21. The sound pressure reducing structure 1 includes, for example, a plurality of λ/4 resonance tubes 201 to 216 arranged in a matrix with the partition 21 interposed therebetween.

In the sound pressure reducing structure 1 according to the modification, the plurality of λ/4 resonance tubes each have a resonance frequency Fₐ higher than the primary resonance frequency F_{b} of the pipeline 10 and lower than the secondary resonance frequency F_{c} of the pipeline. The size L of the connection part 30 in the Y direction satisfies the above Formula (1). Therefore, it is possible to reduce a sound pressure near the primary resonance frequency F_{b} of the pipeline 10 while reducing an installation space as described in the above embodiment.

In the sound pressure reducing structure 1, since the plurality of λ/4 resonance tubes are connected to the pipeline 10 via the connection part 30, the wavefront of the sound wave incident on the pipeline 10 from the first open end 11 is more likely to be disturbed, and the mismatch of the acoustic impedance becomes large. Therefore, a sound pressure near the primary resonance frequency F_{b} of the pipeline 10 can be more effectively reduced.

In the sound pressure reducing structure, a sound pressure is effectively reduced as a transmission loss TL_{sb} expressed by the following Formula (2) increases. When a cross-sectional area S₀ of the pipeline is the same, the transmission loss TL_{sb} increases as a cross-sectional area S_{b} of the λ/4 resonance tube increases. The cross-sectional area S_{b} is, for example, the sum of opening areas of the plurality of λ/4 resonance tubes.

In the sound pressure reducing structure 1 including the plurality of λ/4 resonance tubes (for example, the λ/4 resonance tubes 201 and 202), the cross-sectional area S_{b} of the λ/4 resonance tube can be easily increased. Therefore, a sound pressure near the primary resonance frequency F_{b} of the pipeline 10 can be more effectively reduced.

$$\begin{matrix}[ Mathematical Formula 4 ] & \\ {TL}_{Sb} = 10 {log}_{10} ( 1 + \frac{{m}^{2}}{4} {tan}^{2} {kl}_{b} ) & ( 2 )\end{matrix}$$

$$m = \frac{{S}_{b}}{{S}_{0}}$$

In Formula (2), S₀ represents a cross-sectional area of the pipeline, S_{b} represents a cross-sectional area of the λ/4 resonance tube, k represents a constant, and l_{b} represents a size of the pipeline in the Y direction.

### Application Example

The sound pressure reducing structure 1 described in the above embodiment can be suitably used for applications for reducing various sound pressures. It is preferable that the sound pressure reducing structure 1 is used by being mounted on a vehicle because an installation space can be suppressed. As an example of an application portion, the present invention can be applied to, for a cabin, a dash insulator, a dash panel, a floor carpet, a spacer, a door trim of a door, a soundproofing material in the door trim, a soundproofing material in a compartment, an instrument panel, an instrument center box, an instrument upper box, an air conditioner casing, a roof trim, a soundproofing material in the roof trim, a sun visor, an air conditioning duct for a rear seat, a cooling duct for a battery cooling system in a vehicle with which a battery is equipped, a cooling fan, a trim of a center console, a soundproofing material in a console, a parcel trim, a parcel panel, a headrest of a seat, a seat back of a front seat, a seat back of a rear seat, and the like. The present invention can be applied to, for a trunk, a trim of a trunk floor, a trunk board, a trim of a trunk side, a soundproofing material in the trim, a draft cover, and the like. The present invention can be applied to the inside of a vehicle skeleton or between panels, and can be applied to, for example, a trim of a pillar and a fender. The present invention can also be applied to a configuration near an engine of a vehicle.

### EXAMPLES

Hereinafter, the present invention will be described in more detail with reference to Examples. However, the technical scope of the present invention is not limited only to the following Examples.

### <<Production of Sound Pressure Reducing Structure>>

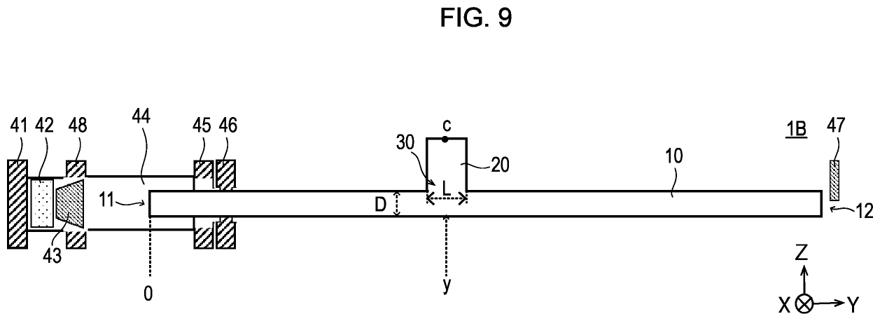

A sound pressure reducing structure 1B illustrated in FIG. 9 was produced as follows. A back plate 41, a sound absorber 42, a speaker 43, a cylindrical tube 44, the pipeline 10, and a microphone 47 were arranged along the extending direction of the pipeline 10. The back plate 41, the sound absorber 42, the speaker 43, and the cylindrical tube 44 were disposed on the first open end 11 side of the pipeline 10, and the microphone 47 was disposed on the second open end 12 side. The speaker 43 was fixed to the cylindrical tube 44 by a flange 48. The cylindrical tube 44 and the pipeline 10 were connected using a flange 45 and a fitting 46. The λ/4 resonance tube 20 is connected to the pipeline 10 via the connection part 30 between the first open end 11 and the second open end 12.

In the sound pressure reducing structure 1B (FIG. 9), a part of the pipeline 10 is inserted into the cylindrical tube 44, and the first open end 11 of the pipeline 10 is provided in the cylindrical tube 44. In the sound pressure reducing structure 1B, the pipeline 10 was inserted into the cylindrical tube 44 by 0.12 m.

As the back plate 41, an acrylic resin back plate having a thickness of 15 mm was used. As the sound absorber 42, White Cuon (registered trademark, manufactured by Tokyo Soundproofing Co., Ltd.) having a thickness of 50 mm was used. As the speaker 43, FE103En (manufactured by Foster Electric Co., Ltd.) was used. As the cylindrical tube 44, an acrylic resin cylindrical tube having an inner diameter of 10 cm was used. The distance between the flange 48 and the flange 45 was 30 cm. As the pipeline 10, a pipeline having a square XZ plane with a side of 4.2 cm was used (see FIG. 2). That is, the size D of the pipeline 10 in the radial direction (X direction) was 4.2 cm. The size of the pipeline 10 in the Y direction was 0.87 m. The primary resonance frequency F_{b} of the pipeline 10 was around 200 Hz. A slit extending in the X direction and the Y direction is provided in one plane (for example, the plane 14 of FIG. 2) constituting the pipeline 10. An adapter (not illustrated) provided with a through hole was disposed in the slit, and a λ/4 resonance tube was connected to the through hole.

As the microphone 47, 378B02 (manufactured by PCB Piezotronics, Inc.) was used. The microphone 47 was calibrated in advance so as to be able to acquire a sound pressure of 94 dB (1 kHz). As the flanges 45 and 48, an acrylic resin flange having a thickness of 15 mm was used. As the fitting 46, an acrylic resin fitting having a square opening with a thickness of 20 mm and a side of 4.2 cm was used.

Table 1 below shows specifications of the sound pressure reducing structure 1B, the connection part 30, and the λ/4 resonance tube used in each Example. When L/D is 0.5 or more, the connection part 30 satisfies Formula (1).

TABLE 1

| | Pipeline | | | | | | | | | | | |
|---|---|---|---|---|---|---|---|---|---|---|---|---|
| | | | | | Discontinuous | | λ/4 resonance tube | | | | | Intersection |
| | | | Primary | Secondary | change position | | | Plane | | | | between |
| | Length | | resonance | resonance | of acoustic | | | shape | | Tube | Resonance | za′ and zb′ |
| | T | D | frequency | frequency | impedance | L/D | L | X × Y | Area | length | frequency | a1 |
| | [m] | [mm] | F_{b} [Hz] | F_{c} [Hz] | b1 [m] | [—] | [mm] | [mm²] | [mm²] | [m] | [Hz] | [m] |
| Example 1 | 0.87 | 42 | 201 | 390 | 0.44 | 0.738 | 31.0 | 20.1 × 31 | 304 | 0.238 | 332 | 0.23 |
| | | | | | | | | (20 sections) | | | | |
| Example 2 | | | | | 0.44 | 0.867 | 36.4 | 20.1 × 36.4 | 365 | 0.238 | 334 | 0.24 |
| | | | | | | | | (24 sections) | | | | |
| Example 3 | | | | | 0.44 | 0.995 | 41.8 | 20.1 × 41.8 | 426 | 0.238 | 340 | 0.24 |
| | | | | | | | | (28 sections) | | | | |
| Example 4 | | | | | 0.44 | 1.124 | 47.2 | 20.1 × 47.2 | 487 | 0.238 | 336 | 0.24 |
| | | | | | | | | (32 sections) | | | | |
| Comparative | | | | | 0.44 | 0.350 | 14.7 | 20.1 × 14.7 | 183 | 0.238 | 331 | 0.23 |
| Example 1 | | | | | | | | (12 sections) | | | | |
| Comparative | | | | | 0.44 | 0.479 | 20.1 | 20.1 × 20.1 | 243 | 0.238 | 331 | 0.23 |
| Example 2 | | | | | | | | (16 sections) | | | | |
| Comparative | | | | | 0.44 | 0.479 | 20.1 | 20.1 × 20.1 | 404 | 0.238 | 350 | 0.24 |
| Example 3 | | | | | | | | (1 section) | | | | |

### <<Evaluation of Sound Pressure Reducing Effect>>

In the sound pressure reducing structure 1B, the sound pressure reducing effect was evaluated as follows while changing the position of the connection part 30 in the Y direction. First, a white noise signal was sent from a signal generation device to the speaker 43 of the sound pressure reducing structure 1B. Thereafter, processing including an FET (FastFourier Transform) operation processing was performed on the signal acquired by the microphone 47. As a result, a measurement result of the sound pressure level was obtained. The frequency of the white noise signal was 100 to 4096 Hz. A system (SCADADSIII, SC310W manufactured by Siemens Corporation) was used for the FET operation processing. The FET operation processing was set to a frequency range of 0 to 4096 Hz, a Hanning window, an average number of times of 30 times, and an overlap of 0%.

### Example 1

In Example 1, as shown in Table 1 above, the sound pressure reducing structure 1B was produced, and the sound pressure reducing effect was evaluated. In Example 1, one λ/4 resonance tube (tube length: 0.238 m, size in X direction: 20.1 mm, size in Y direction: 31.0 mm, resonance frequency: 332 Hz) was connected to the pipeline 10 via the connection part 30. The size L of the connection part 30 was 31.0 mm, and the area of the XY plane was 304 mm². As illustrated in FIG. 8C, one λ/4 resonance tube divided into 20 sections by the partition 21 was used.

### Example 2

The sound pressure reducing effect was evaluated in the same manner as in Example 1 except that one λ/4 resonance tube (tube length: 0.238 m, size in X direction: 20.1 mm, size in Y direction: 36.4 mm, resonance frequency: 334 Hz) was used, the size L of the connection part 30 was changed to 36.4 mm, the area of the XY plane was 365 mm², and as illustrated in FIG. 8D, one λ/4 resonance tube divided into 24 sections by the partition 21 was used.

### Example 3

The sound pressure reducing effect was evaluated in the same manner as in Example 2 except that one λ/4 resonance tube (tube length: 0.238 m, size in X direction: 20.1 mm, size in Y direction: 41.8 mm, resonance frequency: 340 Hz) was used, the size L of the connection part 30 was changed to 41.8 mm, the area of the XY plane was changed to 426 mm², and as illustrated in FIG. 8E, one λ/4 resonance tube divided into 28 sections by the partition 21 was used.

### Example 4

The sound pressure reducing effect was evaluated in the same manner as in Example 3 except that one λ/4 resonance tube (tube length: 0.238 m, size in X direction: 20.1 mm, size in Y direction: 47.2 mm, resonance frequency: 336 Hz) was used, the size L of the connection part 30 was changed to 47.2 mm, the area of the XY plane was changed to 487 mm², and as illustrated in FIG. 8F, one λ/4 resonance tube divided into 32 sections by the partition 21 was used.

The tube length of the λ/4 resonance tube used in each of Examples 1 to 4 is shown in Table 2 below.

TABLE 2

| Section of λ/4 resonance tube | Tube length [m] |
|---|---|
| 201 to 216 (FIG. 8A) | 0.238 |
| A01 to A12 (FIG. 8B) | |
| B01 to B20 (FIG. 8C) | |
| C01 to C24 (FIG. 8D) | |
| D01 to D28 (FIG. 8E) | |
| E01 to E32 (FIG. 8F) | |

### Comparative Example 1

The sound pressure reducing effect was evaluated in the same manner as in Example 3 except that one λ/4 resonance tube (tube length: 0.238 m, size in X direction: 20.1 mm, size in Y direction: 14.7 mm, resonance frequency: 331 Hz) was used, the size L of the connection part 30 was changed to 14.7 mm, the area of the XY plane was changed to 183 mm², and as illustrated in FIG. 8B and Table 2 above, one λ/4 resonance tube divided into 12 sections by the partition 21 was used.

### Comparative Example 2

The sound pressure reducing effect was evaluated in the same manner as in Example 4 except that one λ/4 resonance tube (tube length: 0.238 m, size in X direction: 20.1 mm, size in Y direction: 20.1 mm, resonance frequency: 331 Hz) was used, the size L of the connection part 30 was changed to 20.1 mm, the area of the XY plane was changed to 243 mm², and as illustrated in FIG. 8A and Table 2 above, one λ/4 resonance tube divided into 16 sections by the partition 21 was used.

### Comparative Example 3

The sound pressure reducing effect was evaluated in the same manner as in Example 4 except that one λ/4 resonance tube (tube length: 0.238 m, size in X direction: 20.1 mm, size in Y direction: 20.1 mm, resonance frequency: 350 Hz) was used, the size L of the connection part 30 was changed to 20.1 mm, the area of the XY plane was changed to 404 mm², and one λ/4 resonance tube of one section not including the partition 21 was used.

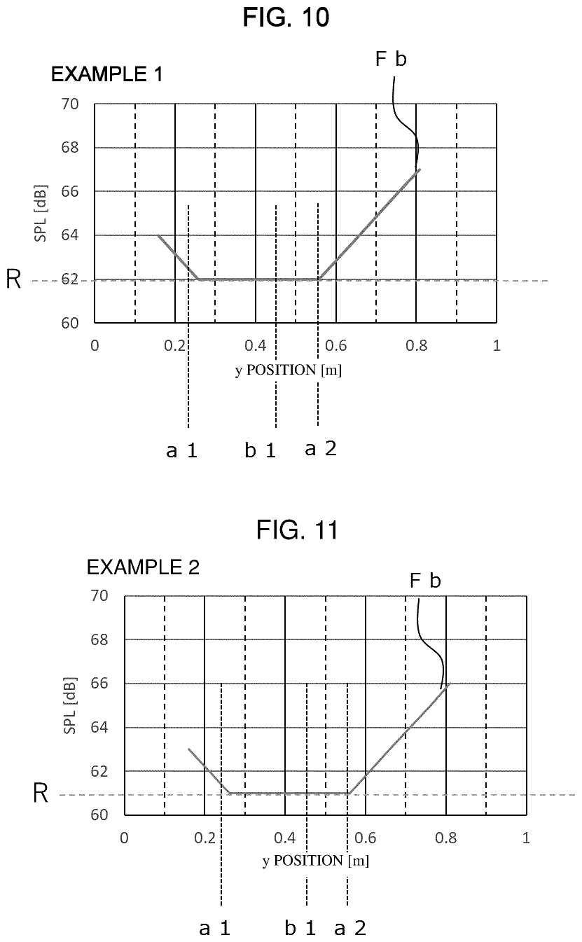

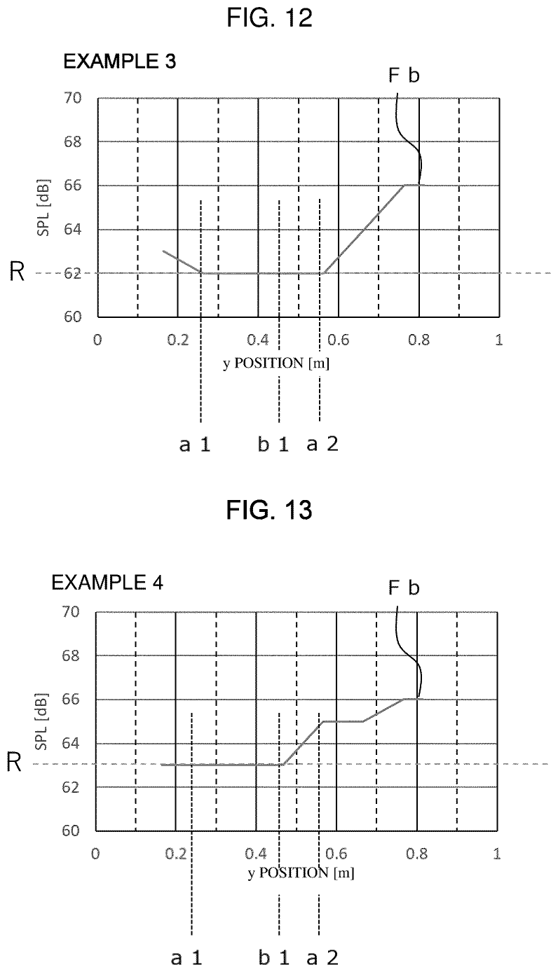

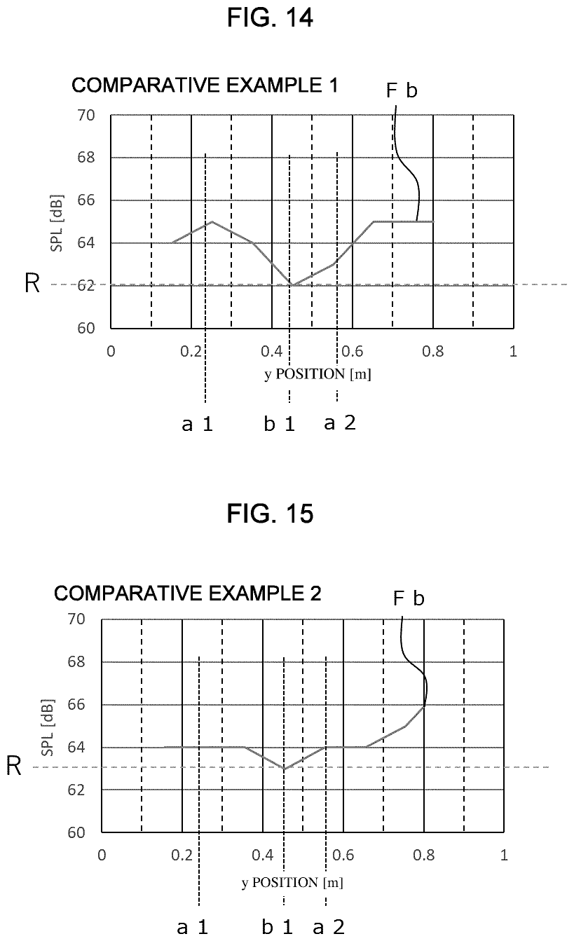

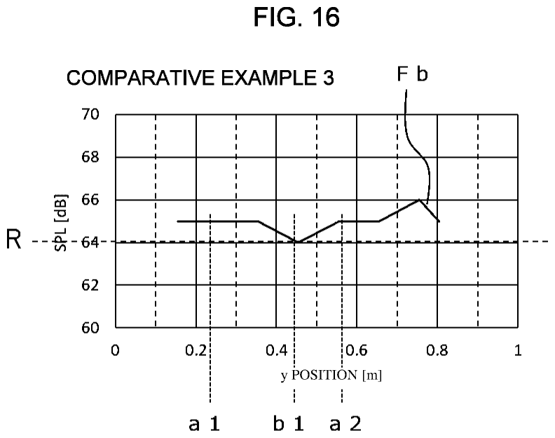

The evaluation results of Examples 1 to 4 and Comparative Examples 1 to 3 are shown in FIGS. 10 to 16. In FIGS. 10 to 16, the horizontal axis represents a distance from the first open end to the center position c of the λ/4 resonance tube in the Y direction, and the vertical axis represents sound pressure (SPL: Sound Pressure Level). When the center position c exists at the first open end 11 of the pipeline 10, the horizontal axis is defined as 0 [m]. A reference value R of the sound pressure is a value of the sound pressure of the primary resonance frequency F_{b} of the pipeline 10 when the center position c is at the change position b1.

In Examples 1 to 4 in which the size L of the connection part 30 satisfies the above Formula (1), the sound pressure near the primary resonance frequency F_{b} of the pipeline 10 hardly deteriorated from the reference value R by disposing the position of the connection part 30 of the λ/4 resonance tube 20 between the position a1 and the change position b1, whereas in Comparative Examples 1 to 3, the sound pressure near the primary resonance frequency F_{b} of the pipeline 10 deteriorated from the reference value R even when the λ/4 resonance tube was disposed at any position other than the change position b1.

The sound pressure reducing structure of the present invention has been described above using the embodiments, the modifications, and Examples. However, the present invention can be appropriately added, modified, and omitted by those skilled in the art within the scope of the technical idea. For example, the configuration, shape, size, and the like of each part of the sound pressure reducing structure described in the above embodiment and the like are merely examples, and other configurations, shapes, sizes, and the like may be used.

For example, in the above embodiment and the like, an example in which one connection part 30 is provided in the pipeline 10 has been described, but a plurality of connection parts 30 may be provided in the pipeline 10. For example, the λ/4 resonance tube is connected to the pipeline 10 via each of the plurality of connection parts 30.

For example, in the above embodiment and the like, the tube length of the section of the resonance tube 20 is constant, but as shown in Table 3, the tube length and the number of times of bending may be changed for each section (an acoustic metamaterial absorber described in WO 2018/047153 A1 can be exemplified, but the present invention is not limited thereto). In the case of the resonance tube 20 with the specifications in Table 3, the lowest (smallest) resonance frequency according to the normal incidence sound absorption coefficient measurement method (2 microphone method) in accordance with ISO 10534-2 is 363 Hz.

TABLE 3

| Section of λ/ | | Number of times |
|---|---|---|
| 4 resonance tube | Tube length | of bending |
| (FIG. 8A) | [m] | [times] |
| 207 | 0.238 | 3 |
| 206 | 0.212 | 3 |
| 210 | 0.191 | 3 |
| 211 | 0.154 | 3 |
| 212 | 0.140 | 2 |
| 209 | 0.128 | 2 |
| 208 | 0.112 | 2 |
| 205 | 0.099 | 2 |
| 201 | 0.086 | 1 |
| 216 | 0.078 | 1 |
| 213 | 0.064 | 1 |
| 204 | 0.053 | 1 |
| 215 | 0.051 | 0 |
| 214 | 0.040 | 0 |
| 202 | 0.026 | 0 |
| 203 | 0.019 | 0 |

In the above embodiment, an example in which the pipeline 10 has a quadrangular plane (XZ plane) shape has been described, but the pipeline 10 may have another plane shape. For example, the pipeline 10 may have a polygonal plane shape of a pentagon or more, or may have a plane shape such as a circle or an ellipse.

1. A sound pressure reducing structure comprising:
a pipeline having a first open end and a second open end in an extending direction;
a λ/4 resonance tube having a resonance frequency higher than a primary resonance frequency of the pipeline and lower than a secondary resonance frequency of the pipeline; and
a connection part provided between the first open end and the second open end, connecting the λ/4 resonance tube to the pipeline, and satisfying the following Formula (1),
wherein the sound pressure reducing structure has
a change position b1 at which an acoustic impedance zb at the primary resonance frequency of the pipeline changes discontinuously along the extending direction, and
a position a1 closest to the first open end among a plurality of intersections between a derivative za′ of an acoustic impedance za of the pipeline at the resonance frequency of the λ/4 resonance tube and a derivative zb′ of the acoustic impedance zb, and
a position of the connection part in the extending direction is between the position a1 and the change position b1:
$$\begin{matrix}[ Mathematical Formula 1 ] & \\ D / 2 < L & ( 1 )\end{matrix}$$
where L represents a size of the connection part in the extending direction, and D represents a size of the pipeline in a radial direction intersecting the extending direction at a position where the connection part is provided.

2. The sound pressure reducing structure according to claim 1, wherein
the pipeline has a pair of planes facing each other, and
the connection part is provided on one of the pair of planes.
